(19) United States
(12) Patent Application Publication
(10) Pub. No.: US 2014/0287724 A1
(43) Pub. Date: Sep. 25, 2014

(54) MOBILE TERMINAL AND LOCK CONTROL METHOD

(71) Applicant: KYOVERA Corporation, Kyoto-shi, Kyoto (JP)

(72) Inventors: Hayato Takenouchi, Kizugawa-shi (JP); Atsuhiko Kanda, Kyotanabe-shi (JP)

(73) Assignee: KYOCERA Corporation

(21) Appl. No.: 14/354,002

(22) PCT Filed: Oct. 11, 2012
(86) PCT No.: PCT/JP2012/076270

§ 371 Date: Apr. 24, 2014

(30) Foreign Application Priority Data
Oct. 25, 2011 (JP) 2011-233813

(51) Int. Cl. H04W 12/08

(52) U.S. Cl. CPC H04W 12/08
USPC 455/411

(57) ABSTRACT

A mobile phone comprises a display and a touch panel that is provided on the display, and is capable of setting a locked state. In a case where the locked state is set, a lock screen including the lock object is displayed on the display. If a long-depressing touch operation is performed to the lock object, shortcut icons corresponding to a telephone function, etc. are displayed on the display instead of the lock object. If the shortcut icon of the telephone function, for example, is selected by a selecting object corresponding to a touch position in the shortcut screen, the locked state is canceled and the telephone function is performed.

### FIELD OF ART

The present invention relates to a mobile terminal and a lock control method, and more specifically, a mobile terminal capable of setting a locked state and a lock control method.

### BACKGROUND ART

An example of a mobile terminal capable of setting a locked state is disclosed in Patent Literature 1. In a mobile terminal device of Patent Literature 1, gestures such as an operation performing a double-tap, etc. are registered for each of operating screens. Then, if a gesture corresponding to an operating screen is performed to a touch panel at a time that an operation of the touch panel is being stopped, the touch panel returns to its normal operation from a stopped state.
Patent Literature 1: Japanese Patent Application Laying-Open No. H11-203045[G06F 3/033, G06F 3/00, H04Q 7/38, H04M 1/02, H04N 1/23]

### SUMMARY OF THE INVENTION

### Problems to be Solved by the Invention

In the mobile terminal device of Patent Literature 1, it is necessary for a user to completely memorize a plurality of operating screens and gestures corresponding the operating screens in a case where the plurality of operating screens are to be registered. If the user forgets a correspondence relationship between the gesture and the operating screen when the touch panel is to be returned from a stopped state to a normal operation, the user cannot operate the mobile terminal satisfactorily.

Therefore, a primary object of the present invention is to provide a novel mobile terminal and a lock control method.

Another object of the present invention is to provide a mobile terminal and a lock control method, capable of easily performing a predetermined function through a touch operation by a user.

### Means for Solving the Problems

The present invention employs following features in order to solve the above-described problems. It should be noted that reference numerals and the supplements inside the parentheses show one example of a corresponding relationship with the embodiments described later for easy understanding of the present invention, and do not limit the present invention.

A first aspect according to the present invention is a mobile terminal capable of setting a locked state that restricts a performance of predetermined processing, comprising: a display portion; a touch panel that is provided on the display portion; a detecting module operable to detect a touch operation to the touch panel; an icon displaying processing module operable to display at least one or more icons corresponding to predetermined functions on the display portion if a long-depressing touch operation to the touch panel is performed at a time that the locked state is being set; a canceling module operable to cancel the locked state if a touch operation for selecting any one of the icons being displayed on the display portion is performed; and a performing module operable to perform, if the touch operation for selecting any one of the icons being displayed on the display portion is performed, a function corresponding to the icon.

A second aspect according to the present invention is a lock control method of a mobile terminal having a display portion, a touch panel that is provided on the display portion and a detecting module operable to detect a touch operation to the touch panel, and capable of setting a locked state that restricts a performance of predetermined processing based on a touch operation to the touch panel, comprising steps of: displaying at least one or more icons corresponding to predetermined functions on the display portion if a long-depressing touch operation to the touch panel is performed at a time that the locked state is being set; canceling the locked state if a touch operation for selecting any one of the icons being displayed on the display portion is performed; and performing, if a touch operation for selecting any one of the icons being displayed on the display portion is performed, a function corresponding to the icon.

### Advantages of the Invention

According to the present invention, the user can easily perform a predetermined function through a touch operation.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an appearance view showing a mobile phone of an embodiment according to the present invention.

FIG. 2 is a view showing electrical structure of the mobile phone shown in FIG. 1.

FIG. 3 is an illustrative view showing an example of a lock screen that is displayed on a display shown in FIG. 1.

FIG. 4 is an illustrative view showing an example of an operation for canceling a locked state being set in the mobile phone shown in FIG. 1, FIG. 4(A) shows a direction of a touch operation that is performed to a lock object shown in FIG. 3, FIG. 4(B) is a displaying example of a state that the lock object is moved out of the screen, and FIG. 4(C) shows a displaying example of a stand-by screen.

FIG. 5 is an illustrative view showing an example of an operation for transiting from the lock screen shown in FIG. 3 to a shortcut screen, FIG. 5(A) shows a touch operation that is performed to the lock object shown in FIG. 3, and FIG. 5(B) is a displaying example of a shortcut screen.

FIG. 6 is an illustrative view showing an example of structure of a shortcut table data that is stored in a RAM shown in FIG. 2.

FIG. 7 is an illustrative view showing an example of an operation for canceling a locked state being set in the mobile phone shown in FIG. 1 and performing an arbitrary function, FIG. 7(A) shows an example of a shortcut screen, FIG. 7(B) shows a state that a touch operation is being performed to a shortcut icon, and FIG. 7(C) shows a displaying example at a time that a telephone function is being performed.

FIG. 8 is an illustrative view showing an example of an operation for transiting from a shortcut screen shown in FIG. 5(B), etc. to a lock screen, FIG. 8(A) shows an example of a touch operation that does not select a shortcut icon, FIG. 8(B) shows a state that a finger is released from a touch panel in the state of FIG. 8(A), and FIG. 8(C) shows a displaying example of the lock screen.

FIG. 9 is an illustrative view showing an example of a memory map of the RAM shown in FIG. 2.

FIG. 10 is a flowchart showing an example of a lock controlling process by a processor shown in FIG. 2.

FIG. 11 is an illustrative view showing an example of an operation for performing a voice controlling function that the mobile phone shown in FIG. 1 is provided with, FIG. 11(A) shows a displaying example of a shortcut screen including a voice control icon V, and FIG. 11(B) shows a displaying example of a state that the voice control icon V shown in FIG. 11(A) is selected and thus the voice controlling function is being performed.

FIG. 12 is an illustrative view showing an example of a memory map of the RAM shown in FIG. 2.

FIG. 13 is a flowchart showing an example of a lock controlling process according to a second embodiment by the processor shown in FIG. 2.

FIG. 14 is an illustrative view showing another example of an operation for performing a voice controlling function in the mobile phone shown in FIG. 1, FIG. 14(A) shows a displaying example of a lock screen, and FIG. 14(B) shows a displaying example of a state that a touch operation to a lock object is performed and thus the voice controlling function is being performed.

FIG. 15 is a flowchart showing an example of a lock controlling process according to a third embodiment by the processor shown in FIG. 2.

FIG. 16 is an illustrative view showing an example of a security screen that is displayed on the display shown in FIG. 1.

FIG. 17 is a flowchart showing an example of a part of a lock controlling process according to the other embodiment by the processor shown in FIG. 2.

### FORMS FOR EMBODYING THE INVENTION

### First Embodiment

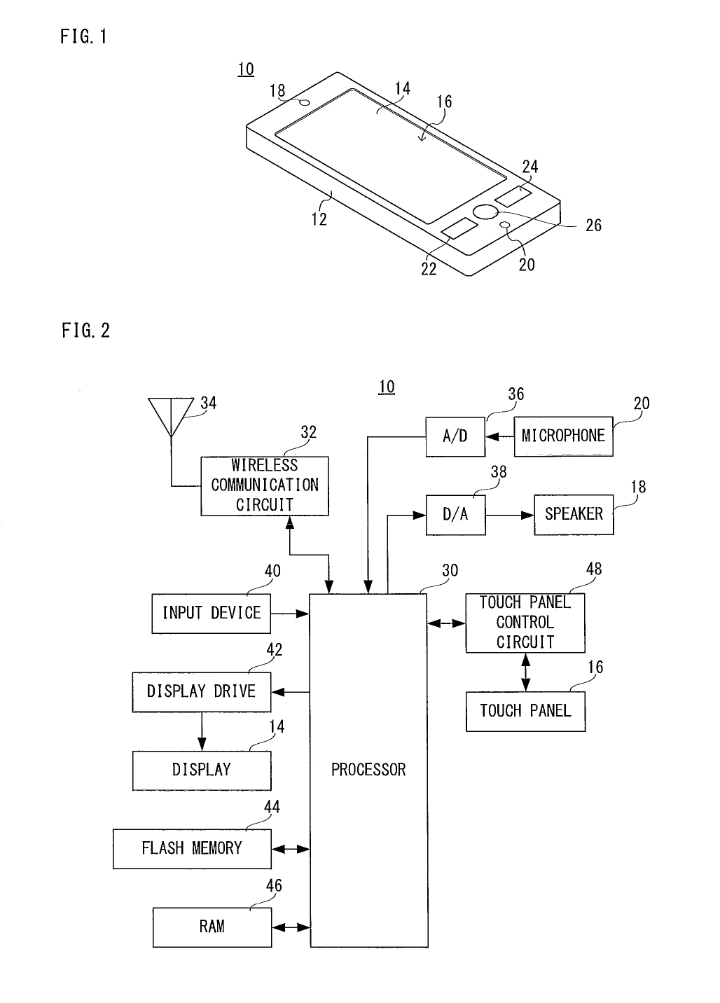

With referring to FIG. 1, a mobile phone 10 of an embodiment according to the present invention is a smartphone as an example, and includes a longitudinal flat rectangular housing 12. However, it is pointed in advance that the present invention can be applied to an arbitrary mobile terminal such as a tablet terminal, a PDA, etc.

A display 14 of a liquid crystal, organic EL or the like, which functions as a display portion, is provided on a main surface (front surface) of the housing 12. A touch panel 16 is provided on the display 14. Therefore, in the mobile phone 10 of this embodiment, the most part of an input operation excepting an input by an operation of a hardware key described later is performed through the touch panel 16.

A speaker 18 is housed in the housing 12 at one end of a longitudinal direction on a side of a front surface, and a microphone 20 is housed at the other end in the longitudinal direction on the side of the front surface.

As a hardware key constituting an input operating module together with the touch panel 16, a call key 22, an end key 24 and a menu key 26 are provided, in this embodiment.

For example, the user can input a telephone number by making a touch operation on the touch panel 16 to a dial key (not shown) displayed on the display 14, and start a telephone communication by operating the call key 22. If the end key 24 is operated, the telephone communication can be ended. In addition, by long-depressing the end key 24, it is possible to turn-on/-off power of the mobile phone 10.

If the menu key 26 is operated, a menu screen is displayed on the display 14, and in such a state, by making a touch operation on the touch panel 16 to a soft key, a menu icon or the like being displayed on the display 14, it is possible to select a menu and to determine such a selection.

With referring to FIG. 2, the mobile phone 10 of the embodiment shown in FIG. 1 includes a processor 30 called as a computer or a CPU. The processor 30 is connected with a wireless communication circuit 32, an A/D converter 36, a D/A converter 38, an input device 40, a display driver 42, a flash memory 44, a RAM 46, a touch panel control circuit 48, etc.

The processor 30 is in charge of a whole control of the mobile phone 10. All or a part of a program set in advance in the flash memory 44 is, in use, developed or loaded into the RAM 46, and the processor 30 operates in accordance with the program developed in the RAM 46. In addition, the RAM 46 is further used as a working area or buffer area for the processor 30.

The input device 40 includes the touch panel 16 and the hardware keys 22, 24 and 26 shown in FIG. 1, and constitutes an operating module or an inputting module. Information (key data) of the hardware key the user operated is input to the processor 30.

The wireless communication circuit 32 is a circuit for transmitting and receiving a radio wave for a telephone communication, a mail, etc. via an antenna 34. In this embodiment, the wireless communication circuit 32 is a circuit for performing a wireless communication with a CDMA system. For example, if the user designates an outgoing call (telephone call) using the input device 40, the wireless communication circuit 32 performs the telephone call processing under instructions from the processor 30 and outputs a telephone call signal via the antenna 34. The telephone call signal is transmitted to a telephone at the other end of the line through a base station and a communication network. Then, when the incoming call processing is performed in the telephone at the other end of the line, a communication-capable state is established and the processor 30 performs the telephonic communication processing.

Specifically describing a normal telephonic communication process, a modulated voice signal sent from a telephone at the other end of the line is received by the antenna 34. The modulated voice signal received is subjected to demodulation processing and decode processing by the wireless communication circuit 32. A received voice signal obtained through such processing is converted into a voice signal by the D/A converter 38 to be output from the speaker 18. On the other hand, a sending voice signal taken-in through the microphone 20 is converted into voice data by the A/D converter 36 to be applied to the processor 30. The voice data is subjected to encode processing and modulation processing by the wireless communication circuit 32 under instructions by the processor 30 to be output via the antenna 34. Therefore, the modulated voice signal is transmitted to the telephone at the other end of the line via the base station and the communication network.

When the telephone call signal from a telephone at the other end of the line is received by the antenna 34, the wireless communication circuit 32 notifies the processor 30 of the incoming call. In response thereto, the processor 30 displays on the display 14 sender information (telephone number and so on) described in the incoming call notification by controlling the display driver 42. In addition, the processor 30 outputs from the speaker 18 a ringtone (may be also called as a ringtone melody, a ringtone voice).

Then, if the user performs an answering operation by using the call key 22 (FIG. 1) included in the input device 40, the wireless communication circuit 32 performs processing for establishing a communication-capable state under instructions by the processor 30. Furthermore, when the communication-capable state is established, the processor 30 performs the above-described telephone communication processing.

If the telephone communication ending operation is performed by the end key 24 (FIG. 1) included in the input device 40 after a state is changed to the communication-capable state, the processor 30 transmits a telephone communication ending signal to the telephone at the other end of the line by controlling the wireless communication circuit 32. Then, after the transmission of the telephone communication ending signal, the processor 30 terminates the telephone communication processing. Furthermore, in a case that the telephone communication ending signal from the telephone at the other end of the line is received before the telephone communication ending operation at this end, the processor 30 also terminates the telephone communication processing. In addition, in a case that the telephone communication ending signal is received from the mobile communication network not from the telephone at the other end of the line, the processor 30 also terminates the telephone communication processing.

The microphone 20 shown in FIG. 1 is connected to the A/D converter 36, and as described above, a voice signal from the microphone 20 is input to the processor 30 as digital voice data through the A/D converter 36. The speaker 18 is connected to the D/A converter 38. The D/A converter 38 converts digital voice data into a voice signal so as to apply to the speaker 18 via an amplifier. Therefore, a voice of the voice data is output from the speaker 18.

In addition, the processor 30 adjusts, in response to an operation for adjusting a volume by the user, a sound volume of the sound output from the speaker 18 by controlling an amplification factor of the amplifier connected to the D/A converter 38.

The display driver 42 is connected to the display 14 shown in FIG. 1 and the display 14 displays videos or images in accordance with video data or image data output from the processor 30. In other words, the display driver 42 controls displaying by the display 14 which is connected to the display driver 40 under instructions by the processor 30. In addition, the display driver 42 includes a video memory for temporarily storing image data to be displayed. The display 14 is provided with a backlight which includes a light source of an LED or the like, for example, and the display driver 42 controls, according to the instructions from the processor 30, brightness, light-on/-off of the backlight.

The touch panel 16 shown in FIG. 1 is connected to a touch panel control circuit 48. The touch panel control circuit 48 applies to the touch panel 16 a necessary voltage or the like and inputs to the processor 30 a touch start signal indicating a start of a touch by the user to the touch panel 16, a touch end signal indicating an end of a touch by the user, and coordinates data indicating a touch position that the user touches. Therefore, the processor 30 can determine which icon or key is touched by the user based on the coordinates data.

In the embodiment, the touch panel 16 is of an electrostatic capacitance system that detects a change of an electrostatic capacitance between electrodes, which occurs when an object such as a finger is in close to a surface of the touch panel 16, and it is detected that one or more fingers are brought into contact with the touch panel 16, for example. Furthermore, the touch panel 16 is provided on the display 14, and serves as a pointing device for designating an arbitrary position within the screen. The touch panel control circuit 48 functions as a detecting module for detecting a touch operation, and, more specifically, detects a touch operation within a touch-effective range of the touch panel 16, and outputs coordinates data indicative of a position of the touch operation to the processor 30. That is, the user inputs to the mobile phone 10 an operation position, an operation direction and so on through a touch, slide or release operation or through a combination of these operations on the surface of the touch panel 16.

In addition, for a detection system of the touch panel 16, a surface-type electrostatic capacitance system may be adopted, or a resistance film system, an ultrasonic system, an infrared ray system, an electromagnetic induction system or the like may be adopted. Furthermore, a touch operation is not limited to an operation by a finger, may be performed by a stylus or the like.

In addition, although a detailed description is omitted here, the mobile phone 10 has, in addition to a telephone function, a time function that a time for each set area is managed, a schedule function, an address book function that address data being stored is managed, a search function that searches data, a setting function that a setting of the mobile phone 10 is changed. Furthermore, the mobile phone 10 can perform, through a communication with a network, a mail function, a browser function, a SMS (Short Message Service) function, a blog function for making a post (an upload) on blogs, etc. The mobile phone 10 also has a music function and a video function that music data or video data being stored in the flash memory 44 or a server on the network are reproduced.

In addition, the above-described wireless communication circuit 32, A/D converter 34 and D/A converter 36 may be included in the processor 30.

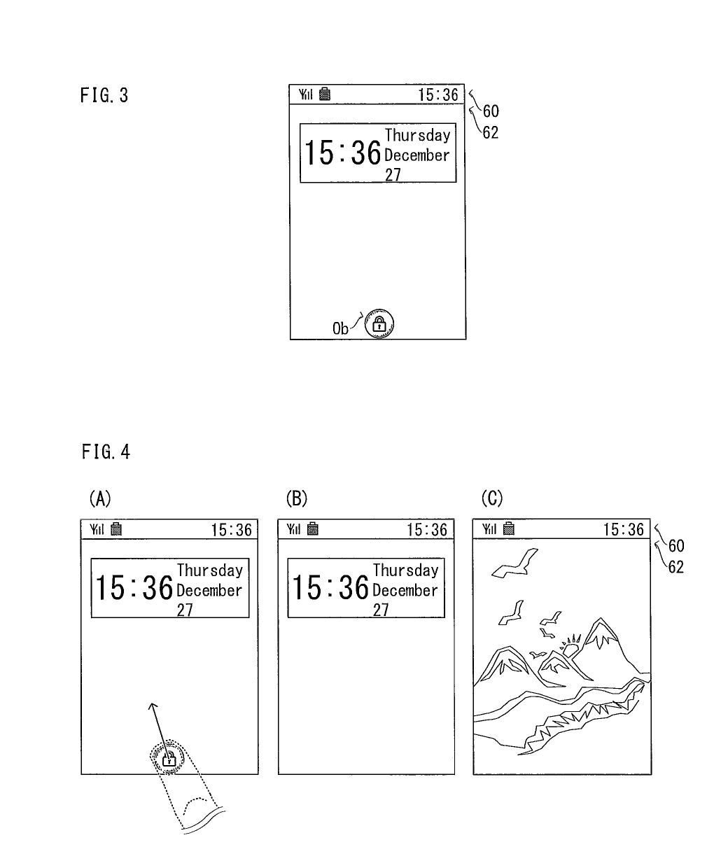

Here, the mobile phone 10 has a lock function that the above-described respective functions in the mobile phone 10 are made not to be performed by the touch operation. If the end key 24 is operated, for example, a power for the display 14 and the touch panel 16 is turned-off and a locked state is set. Then, if the end key 24 is operated, the power for the display 14 and the touch panel 16 is turned-on, and a lock screen (first screen) shown in FIG. 3 is displayed such that a canceling operation of the locked state becomes to be accepted.

Furthermore, in the locked state in this embodiment, the power of the display 14 and the touch panel 16 is turned-off until the lock screen is displayed, and therefore, the electric power consumption is suppressed. However, in another embodiment, when the lock screen is being displayed, the power of the touch panel 16 may not be turned-off and the touch operation may be made invalid by processing by the processor 30 the touch operation is to be ignored.

With referring to FIG. 3, a displaying range of the display 14 that displays a lock screen includes a status displaying area 60 and a function displaying area 62. In the status displaying area 60, an icon (picto) showing a radio-wave receiving status by the antenna 34, an icon showing a residual battery capacity of a secondary battery and time are displayed. Furthermore, in the function displaying area 62, the current time and date are displayed, and a lock object Ob is displayed at a lower center. A displaying position of the lock object Ob is changed according to a position of a finger of a user, that is, a current touch position. In addition, in a case where there is an incoming telephone call that has not been responded to, an email that has not been opened, or the like, a pop-up for notifying them is displayed on the lock screen.

Then, if a predetermined touch operation is performed to the lock object Ob, a locked state is canceled. With referring to FIG. 4(A), for example, if the finger is slid such that a moving distance of the lock object Ob becomes more than a predetermined distance and then the finger is released from the lock object Ob, as shown in FIG. 4(B), the lock object Ob is non-displayed. If the lock object Ob is non-displayed, in the function displaying area 62 of the display 14, a stand-by screen shown in FIG. 4(C) is displayed. The locked state is also canceled in a case where a touch operation (flick) that the lock object Ob is flicked with a predetermined speed or more is performed. Thus, in this embodiment, in order to make the user operate the lock object Ob with one hand, the lock object Ob is displayed at a lower center of the screen. Therefore, the user can easily perform a cancel operation of the locked state with one hand. Furthermore, a direction of the touch operation to the lock object Ob for canceling the locked state is not restricted, and therefore, the cancel operation of the locked state can be performed easily with either a left hand or a right hand.

In addition, if the moving distance of the lock object Ob is less than the predetermined distance, or if the speed of the flick is slow, the locked state is not canceled and the lock object Ob returns to its original position.

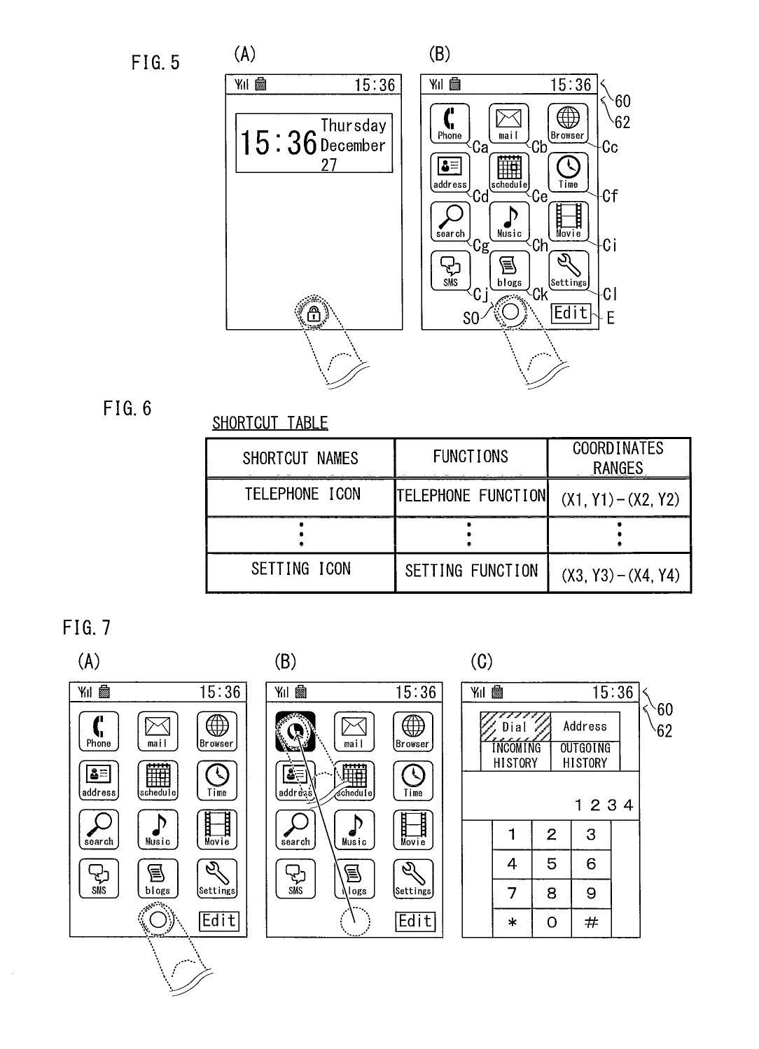

Next, with referring to FIG. 5(A), if a touch operation (a long-depressing touch operation) that the lock object Ob is continuously touched for a predetermined time period (3 seconds, for example) or more is performed, in the function displaying area 62, a shortcut screen (a second screen) is displayed. In the shortcut screen, a plurality of shortcut icons C corresponding to the above-described plurality of functions, edit icons E for editing the respective shortcut icons C, and a selecting object SO for selecting these icons are displayed.

Shortcut icons C displayed in the shortcut screen include a telephone icon Ca corresponding to the telephone function, a mail icon Cb corresponding to the mail function, a browser icon Cc corresponding to the browser function, an address book icon Cd corresponding to the address book function, a schedule icon Ce corresponding to the schedule function, a time icon Cf corresponding to the time function, a search icon Cg corresponding to the search function, a music icon Ch corresponding to the music function, a video icon Ci corresponding to the video function, an SNS icon Cj corresponding to the SNS function, a blog icon Ck corresponding to the blog function and a setting icon Cl corresponding to the setting function.

An initial displaying position of the selecting object SO in the function displaying area 62 is at a lower center as the same as the displaying position of the lock object Ob. Then, the displaying position of the selecting object SO is changed according to a position of the finger of the user, that is, the current touch position.

With referring to FIG. 6, the respective shortcut icons C are managed by a shortcut table that is stored in the RAM 46. The shortcut table includes a column of shortcut names that names of the shortcut icons are recorded, a column of functions that functions corresponding to the shortcut icons are recorded and a column of the displaying ranges indicating coordinates of the displaying ranges of the shortcut icons. Then, in correspondence to the shortcut name, the function and the displaying range are associated with each other in each line.

With referring to the line of “telephone icon”, for example, the telephone function is associated with the telephone icon Ca, and an image of the telephone icon Ca is displayed within coordinates range indicated by “(X1, Y1)-(X2, Y2)”. Similarly, with referring to the line of “setting icon”, the setting function is associated with the setting icon Cl, and an image of the setting icon Cl is displayed within coordinates range indicated by “(X3, Y3)-(X4, Y4)”.

Next, if the user moves his/her finger to an arbitrary shortcut icon C in the shortcut screen while the finger is not released from the shortcut screen, it becomes a state that the shortcut icon C is selected by the selecting object SO, and therefore, a displaying manner is changed. Then, if the finger is released from the lock object Ob in the state that the shortcut icon C is selected, the locked state is canceled and the function corresponding to the shortcut icon C is performed.

With referring to FIG. 7(A) and FIG. 7(B), for example, if the user moves the finger to select the telephone icon Ca by the selecting object SO, a color of the telephone icon Ca is reversed. If the user releases the finger from the touch panel in this state, the locked state is canceled and the telephone function is performed. When the telephone function is performed, a GUI for the telephone function is displayed in the function displaying area 62 of the display 14 as shown in FIG. 7(C).

Accordingly, in this embodiment, by long-depressing the lock object Ob in the lock screen, the user can shift the screen to the shortcut screen. Then, the user can cancel the locked state and perform the function corresponding to the shortcut icon C that is selected by moving his/her finger while keeping a touch to the touch panel such that the finger is released from the lock object Ob in a state that the shortcut icon C corresponding to an arbitrary function is selected. That is, the user can simply cancel the locked state and perform the predetermined function only by combining the touch operations.

Furthermore, in this embodiment, by utilizing the lock object Ob that is being displayed, it is possible to urge the user to perform a touch operation for shifting to the shortcut screen, and accordingly, the displaying of the lock screen can be made simple.

Furthermore, by displaying the shortcut icon C instead of the lock object Ob, it is possible to effectively utilize the lock screen including the lock object Ob. If the shortcut icon C is also to be displayed in the lock screen, for example, it is necessary to make the displaying of the above-described pop-up and the date and time small. If doing so, the displaying of the lock screen that is frequently seen by the user for confirming the time and so on becomes difficult to be seen. In contrast, in this embodiment, since the shortcut icon C and lock object Ob are not displayed together on one screen, and therefore, the above-described problem does not occur.

Furthermore, in the shortcut screen, the selecting object SO is displayed in correspondence to the touch position, and therefore, it becomes easy for the user to perform the touch operation for selecting the shortcut icon C. Especially, in this embodiment, since the displaying manner of the shortcut icon C that is selected is changed, the user can clearly recognize the shortcut icon C that is selected by the touch operation.

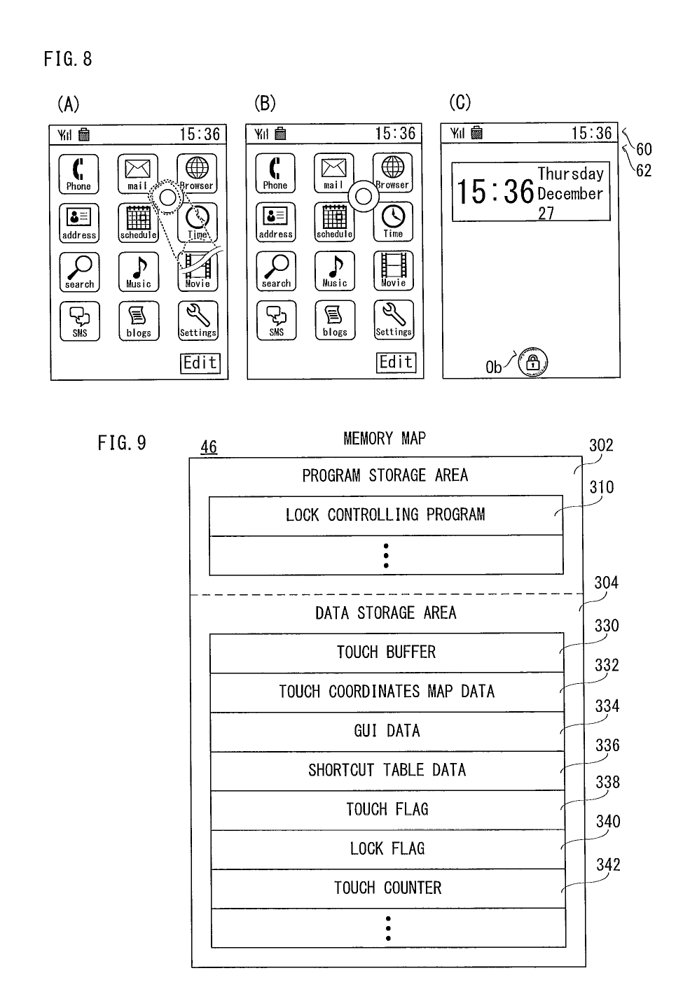

Here, with referring to FIG. 8(A), if the finger is released from the selecting object SO as shown in FIG. 8(B) while the shortcut icon C is not selected by the selecting object SO, the screen returns to the lock screen from the shortcut screen as shown in FIG. 8(C). However, in another embodiment, by providing a dedicated icon for returning to the lock screen from the shortcut screen in the shortcut screen, if the finger is released from the selecting object SO in a state that the dedicated icon is selected, the screen may return to the lock screen.

Furthermore, although a detailed illustration of the touch operation is omitted, if the finger is released from the selecting object SO in a state that the edit icon E is selected by the selecting object SO, the screen is shifted to the editing screen for rearranging displaying positions of the respective shortcut icons C or for adding or deleting the shortcut icon C. Then, in the editing screen, if the editing to the shortcut icon C is performed, the content of the aforementioned shortcut table (FIG. 6) is changed in response thereto. Thus, by selecting the edit icon E, it is possible to edit the shortcut icon C so as to make the usability for the user improved.

Furthermore, in this embodiment, the selecting object SO at a position that is not overlapped with the displaying of the shortcut icon C and the edit icon E such that the function is not erroneously performed at a time that the finger of the user is released. In a case where an arbitrary shortcut icon C is selected at a time that the shortcut screen is being displayed, for example, if the user erroneously releases the finger, the function corresponding to the shortcut icon C would be performed against the user's intention; however, it is possible to suppress an erroneous operation from occurring by displaying the selecting object SO at a position that is not overlapped with the displaying of another icon.

In addition, in another embodiment, by selecting a plurality of shortcut icons C by the selecting object SO, the locked state is canceled and a plurality of functions are simultaneously performed. That is, by making a plurality of functions simultaneously be performed, the convenience for the user can be increased.

If the finger is released from the selecting object SO in a state that the mail icon Cb and the browser icon Cc next to the mail icon Cb on the right are simultaneously selected by the selecting object SO, for example, the locked state is canceled, and the mail function and the browser function are simultaneously performed. Furthermore, when the two functions are simultaneously performed, the function displaying area 62 of the display 14 is divided into two regions, and the mail function and the browser function are displayed on the respective divided regions. Therefore, the user can produce a new mail while performing information search by the browser function.

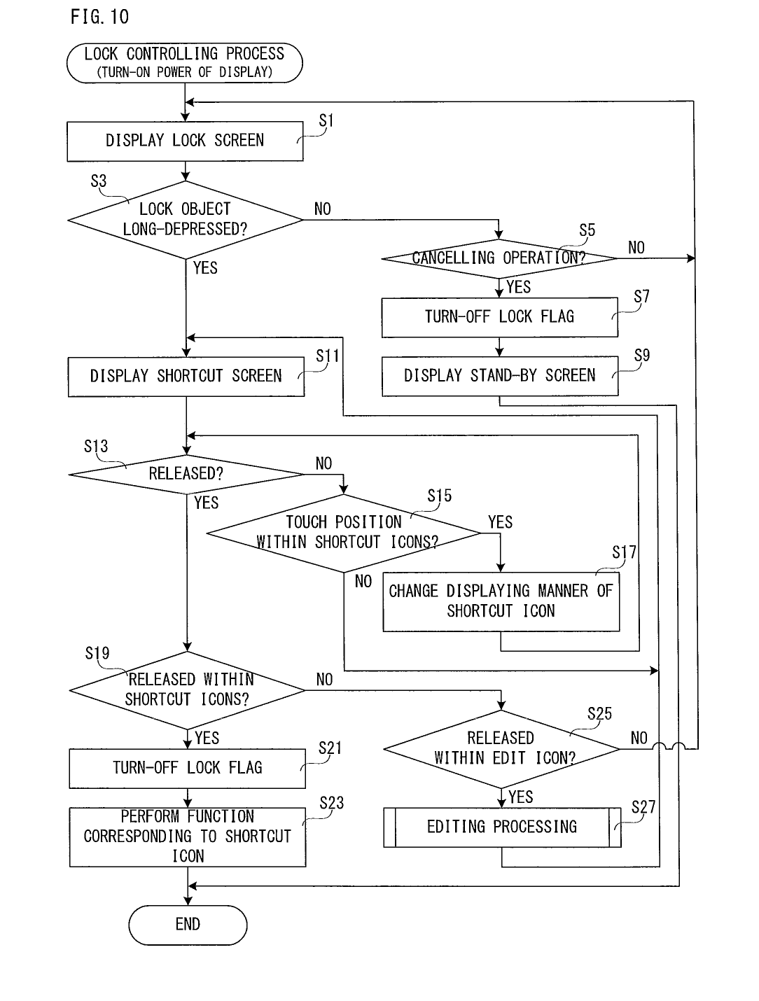

Although the features of the embodiments are roughly described in the above, in the following, the features will be described in detail with using a memory map shown in FIG. 9 and a flowchart shown in FIG. 10.

With referring FIG. 9, the RAM 46 shown in FIG. 2 is formed with a program storage area 302 and a data storage area 304. As previously described, the program storage area 302 is an area for reading and storing (developing) a part or a whole of program data that is set in advance in the flash memory 44 (FIG. 2).

A lock controlling program 310 for canceling a locked state or for canceling a locked state and performing a function, etc. are included in the program storage area 302. In addition, the program storage area 302 also includes programs for performing a mail function, a browser function etc.

The data storage area 304 of the RAM 46 is provided with a touch buffer 330, and stored with touch coordinates map data 332, GUI data 334 and shortcut table data 336. The data storage area 304 is further provided with a touch flag 338, a lock flag 340 and a touch counter 342.

The touch buffer 330 is stored with touch coordinates data that is output from the touch panel control circuit 48. The touch coordinates map data 332 is data for mapping touch coordinates of the touch operation and displaying coordinates of the display 14 with each other. That is, a result of the touch operation performed to the touch panel 16 is reflected in the displaying of the display 14 based on the touch coordinates map data 332.

The GUI data 334 is image data for displaying the lock object Ob, the shortcut icons C, the selecting object SO, the edit icon E and other GUIs. The shortcut table data 336 is data that the shortcut icons C and the functions corresponding to the icons are stored with being associated with each other as shown in FIG. 6.

The touch flag 338 is a flag for determining whether a touch to the touch panel 16 is performed. The touch flag 338 is constructed by a 1-bit register, for example. If the touch flag 338 is turned-on (true), a data value “1” is set in the register, and if the touch flag 338 is turned-off (false), a data value “0” is set in the register. In addition, the touch flag 338 is switched on/off based on a signal that the touch panel control circuit 48 outputs.

Furthermore, the lock flag 340 is a flag for indicating whether the locked state is set. The lock flag 340 is turned-on in response to the processing for turning-off the power of the display 14 and the touch panel 16. The lock flag 340 is turned-off in response to the processing of the above-described lock controlling program 310. Since the structure of the lock flag 340 is approximately the same as that of the touch flag 338, a detailed description of the structure is omitted.

The touch counter 342 is a counter for measuring the time period that the touch panel 16 is being touched. The touch counter 342 is reset and starts the count (measure) when the touch panel is touched, and accordingly, the touch counter 342 may be called as a touch timer.

The data storage area 304 is stored with the image data that is displayed in the stand-by state, data of character strings, and provided with counters and flags necessary for operation of the mobile phone 10.

The processor 30 processes a plurality of tasks including a lock controlling process shown in FIG. 10, etc., in parallel with each other under controls of Linux (registered trademark)-base OS such as Android (registered trademark) and REX, or other OSs.

The lock controlling process is started when the power of the display 14 is turned-on in a state that the locked state is set (the lock flag 340 is turned-on).

In a step S1, the processor 30 acquires date and time information from an RTC and reads the image data of the lock object Ob included in the GUI data 334 to display the lock screen as shown in FIG. 3 in the function displaying area 62 of the display 14. In addition, the processor 30 that performs the processing in the step S1 functions as an object displaying processing module.

Subsequently, in a step S3, the processor 30 determines whether the lock object Ob is long-depressed. That is, it is determined whether a predetermined time period (3 seconds, for example) is counted by the touch counter 342 in a state that the coordinates of the current touch position being saved in the touch buffer 330 is included in the displaying area of the lock object Ob. If “NO” is determined in the step S3, that is, no touch operation is performed to the touch panel 16, for example, the processor 30 determines whether a canceling operation is performed in a step S5. For example, it is determined whether the touch operation of the flick that the lock object Ob is quickly moved out of the screen or a touch operation of the slide that the lock object Ob is moved at more than the predetermined distance is performed.

If “YES” is determined in the step S5, that is, if the canceling operation of the locked state is performed, the processor 30 turns-off the lock flag 340 in a step S7, and displays the stand-by screen in a step S9, and then terminates the lock controlling process. That is, if the canceling operation is performed, the locked state is canceled and the stand-by screen as shown in FIG. 4(C) is displayed in the function displaying area 62 of the display 14. Furthermore, if “NO” is determined in the step S5, that is, if no touch operation is performed to the touch panel 16, for example, the process returns to the step S1, and the lock screen is displayed again. In addition, if the moving distance of the lock object Ob is less than the predetermined distance or the speed of the flick is slow, “NO” is also determined in the step S5, and the lock screen is re-displayed, and accordingly, the displaying position of the lock object Ob returns to its original position.

If “YES” is determined in the step S3, that is, if the predetermined time period elapses while the lock object Ob is continuously touched, the processor 30 displays the shortcut screen as shown in FIG. 5(B), for example, in a step S11. In addition, the processor 30 that performs the processing in the step S11 functions as an icon displaying processing module.

Subsequently, in a step S13, the processor 30 determines whether the finger is released. It is determined whether the finger of the user is released from the touch panel 16 and thus, the touch flag 338 is turned-off, for example. If “NO” is determined in the step S13, that is, if the finger is not released, in a step S15, the processor 30 determines whether the touch position is within the shortcut icon. That is, it is determined whether any one of the shortcut icons C is selected. Specifically, the processor 30 reads the coordinates ranges of the shortcut icons from the shortcut table data 336, and determines whether the current touch position that is saved in the touch buffer 330 is included in any one of the coordinates ranges. If “NO” is determined in the step S15, that is, if the touch position is not changed as shown in FIG. 7, for example, the process returns to the step S11. On the other hand, if “YES” is determined in the step S15, that is, if the current touch position is included in the coordinates range of the telephone icon Ca as shown in FIG. 7(B), for example, the processor 30 changes the displaying manner of the shortcut icon in a step S17, and then, the process returns to the step S13. In the step S17, a color of the telephone icon Ca that the touch position is included is reversed as shown in FIG. 7(B), for example.

If “YES” is determined in the step S13, that is, if the touch flag 338 is changed from the on state to the off state, it is determined in a step S19, whether the finger is released within the shortcut icon. That is, the processor 30 reads the coordinates ranges of the shortcut icons from the shortcut table data 336 and reads coordinates of a release point from the touch buffer 330, and then determines whether the release point is included in the coordinates ranges of the shortcut icons. If “YES” is determined in the step S19, that is, if any one of the shortcut icons C is selected, the processor 30 turns-off the lock flag 340 in a step S21 and performs the function corresponding to the shortcut icon in a step S23, and then, terminates the lock controlling process. If the finger is released from the telephone icon Ca in the state shown in FIG. 7(B), for example, the locked state is canceled and the telephone function is performed. In addition, the processor 30 that performs the processing in the steps S21 and S23 functions as a performing module.

Furthermore, if “NO” is determined in the step S19, that is, if the finger is not released in the state that the shortcut icon C is selected, it is determined in a step S25, whether the finger is released within the edit icon E. That is, it is determined whether the edit icon E is selected. If “NO” is determined in the step S25, that is, if the finger is released in a state that neither the shortcut icon C nor the edit icon E is selected as shown in FIG. 8(B), the process returns to the step S1 to display the lock screen. Furthermore, if “YES” is determined in the step S25, that is, if the edit icon E is selected, the editing processing is performed in a step S27, and then, the process returns to the step S13. If the editing processing is performed, the editing screen of the shortcut icons C is displayed on the display 14, and an editing operation with respect to the shortcut icons C is received. The processor 30 that performs the processing in the step S27 functions as an editing module. In addition, in another embodiment, if the editing processing is ended, the process may return to the step S1 to display the lock screen.

Thus, in this embodiment, since the above-described process is performed, the user can easily perform a predetermined function through a touch operation.

In addition, in a case where a plurality of shortcut icons C are selected, in the step S17 of the lock controlling process, the displaying manners of the plurality of shortcut icons C being selected are changed, and in the step S23, the functions respectively corresponding to the plurality of shortcut icons C being selected are performed.

### Second Embodiment

In the second embodiment, by recognizing a voice of the user, the locked state is canceled and a function based on a voice recognition result is performed. In the following, the second embodiment will be described, but the second embodiment is the same as the first embodiment except the above, and therefore, a duplicate description will be omitted.

The mobile phone 10 has a voice controlling function that a voice of the user is recognized through a voice recognizing process and a function is performed based on a voice recognition result. If the user inputs to the microphone 20, “telephone” in a state that a voice controlling function is performed, a character string of “telephone” is obtained as a voice recognition result. Then, the recognition result is searched in a voice controlling table that the voice recognition results and the predetermined functions are associated with each other, and if there is a predetermined function that is coincident with the recognition result, the predetermined function corresponding to the voice recognition result, that is, the telephone function corresponding to “telephone” is performed.

Here, in the second embodiment, the voice controlling function is performed if a specific touch operation is performed in the shortcut screen. If the voice recognition result of the voice that the user inputs is coincident with the predetermined function in that state, the locked state is canceled and the function based on the voice recognition result is performed.

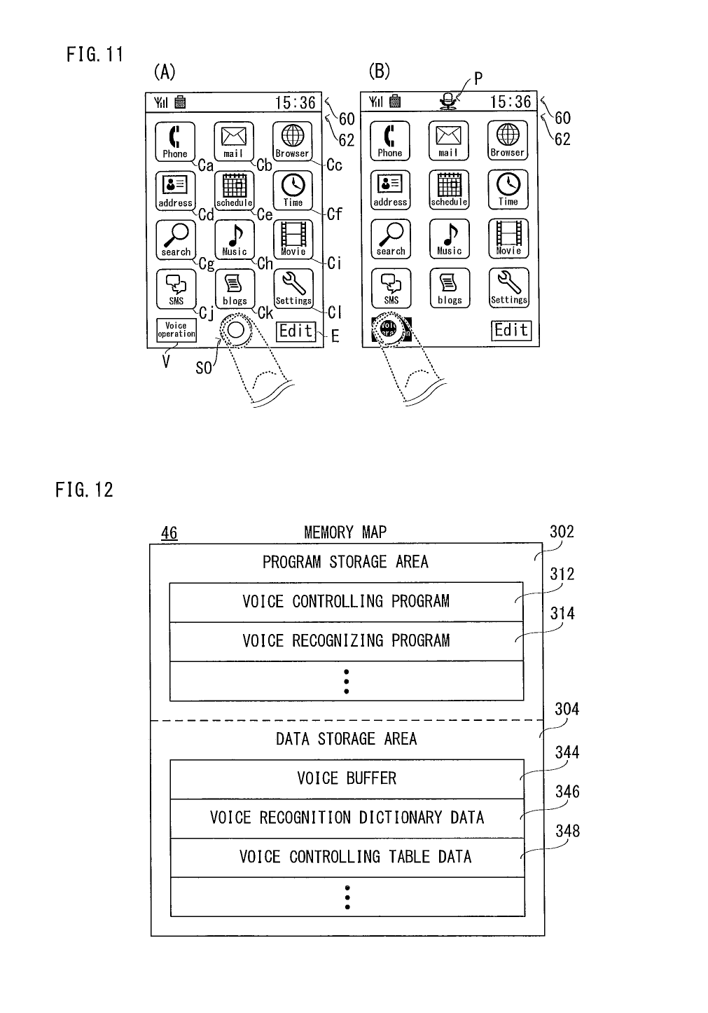

With referring to FIG. 11(A) and FIG. 11(B), in the shortcut screen of the second embodiment, a voice control icon V corresponding to the voice controlling function is displayed at the lower left. Then, if the voice control icon V is selected by the selecting object SO, the voice controlling function is performed, and a voice controlling picto P indicating that the voice controlling function is being performed is displayed in the status displaying area 60. In this state, if the user inputs a voice “mail” corresponding to the mail function, the voice recognizing processing is performed, and the mail function corresponding to the recognition result “mail” is performed.

Thus, in this embodiment, the user can perform the predetermined function only by inputting a voice in addition to the touch operation.

Furthermore, the user can easily grasp that the voice controlling function is being performed through a confirmation of the voice controlling picto P that is being displayed on the display 14.

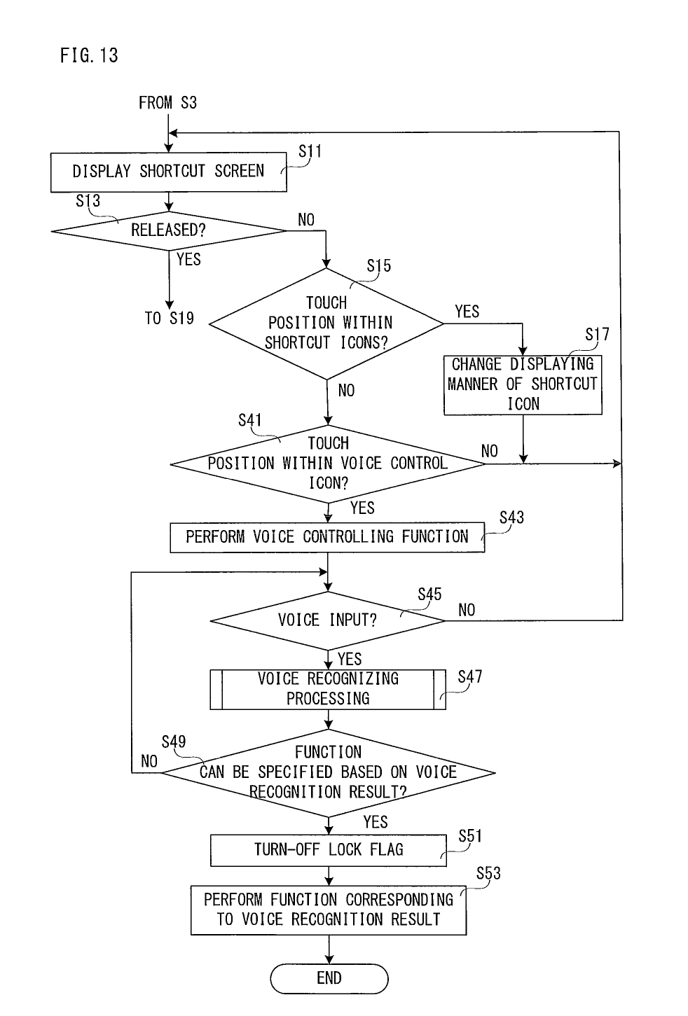

Although the features of the second embodiment are roughly described in the above, in the following, the second embodiment will be described in detail with using a memory map of the second embodiment shown in FIG. 12 and a flowchart shown in FIG. 13.

With referring to FIG. 12, the program storage area 302 of the second embodiment is stored with a voice controlling program 312 corresponding to the voice controlling function and a voice recognizing program 314 that recognizes a voice that is input based on a voice recognition dictionary, in addition to the programs of the first embodiment.

The data storage area 304 of the second embodiment is, in addition to the buffers and data of the first embodiment, provided with a voice buffer 344 that the voice being input is temporarily stored, and stored with voice recognition dictionary data 346 that the feature of the voice data and the character string are associated with each other and voice controlling table data 348 that the voice recognition result and the predetermined function are associated with each other.

The processor 30 of the second embodiment processes a plurality of tasks including a lock controlling process including the flowchart shown in FIG. 13, etc., in parallel with each other.

In the lock controlling process according to the second embodiment, if the touch position is not included within the shortcut icons while the shortcut screen including the voice control icon V shown in FIG. 11(A) is being displayed, “NO” is determined in the step S15, and then, the process by the processor 30 proceeds to the step S41.

The processor 30 determines whether the touch position is within the voice control icon V in the step S41. That is, it is determined whether the voice control icon V is selected by the selecting object SO. If “NO” is determined in the step S41, that is, if the voice control icon V is not selected, the process by the processor 30 returns to the step S11.

On the other hand, if “YES” is determined in the step S41, that is, if the voice control icon V is selected, the processor 30 performs the voice controlling function in a step S43. When the voice controlling function is performed, the voice control picto P is displayed in the status displaying area 60 and a color of the voice control icon V is reversed, for example. Next, the processor 30 determines whether a voice is input in a step S45. That is, it is determined whether voice data is stored in the voice buffer 344. If “NO” is determined in the step S45, that is, if no voice is input, the process by the processor 30 returns to the step S11.

If “YES” is determined in the step S45, that is, if the user inputs a voice “telephone”, for example into the microphone 20, the processor 30 performs the voice recognizing processing in a step S47. That is, the voice recognizing processing is applied to the voice data that is saved in the voice buffer 344. Subsequently, the processor 30 determines whether the function can be specified based on the voice recognition result in a step S49. That is, it is determined whether the voice recognition result is included in the voice controlling table data 348. If “NO” is determined in the step S49, that is, if the voice recognition result is not included in the voice controlling table data 348, the process by the processor 30 returns to the step S45.

On the other hand, if “YES” is determined in the step S49, that is, if the voice recognition result (“telephone”, for example) is included in the voice controlling table data 348, the processor 30 turns-off the lock flag 340 in a step S51, and performs the function (telephone function) corresponding to the voice recognition result in a step S53, and then, terminates the lock controlling process. The processor 30 that performs the processing of the steps S51 and S53 functions as a performing module.

In addition, in a case where “YES” is determined in the step S41 in a state that the voice recognizing function is being performed, the step S43 for performing the voice controlling function is omitted. Furthermore, in a case where the touch position comes out of the voice control icon V in the state that the voice recognizing function is performed, the voice recognizing function is ended. Furthermore, if the finger is released in a state that the voice control icon V is selected, the voice controlling function is performed to display a GUI of the voice controlling function on the display 14.

### Third Embodiment

In the third embodiment, by recognizing a voice of the user at a time that the lock screen is being displayed, the locked state is canceled and the function based on the voice recognition result is performed. Although the third embodiment will be described in the following, because the third embodiment is the same as the first embodiment and the second embodiment except the above, a duplicate description will be omitted.

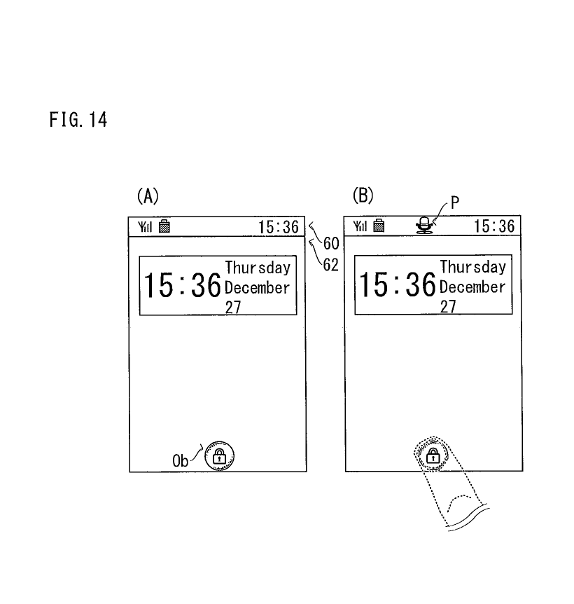

With referring to FIG. 14(A) and FIG. 14(B), if the touch operation to the lock object Ob that is displayed in the lock screen is performed, the voice controlling function is performed, and the voice control picto P is displayed in the status displaying area 60. The user can cancel the locked state and perform the predetermined function based on the voice recognition result by inputting a voice of “telephone”, “mail” or the like in that state. The user can cancel the locked state and perform an arbitrary function by thus inputting a voice at a time that the locked state is set.

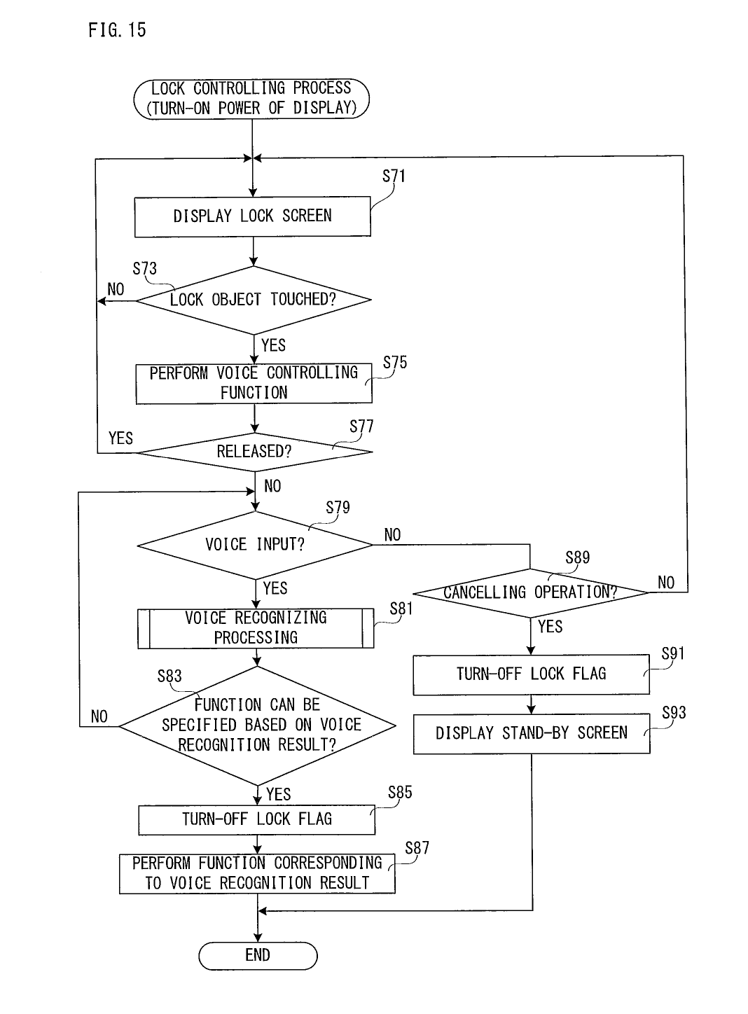

The processor 30 according to the third embodiment processes a plurality of tasks including a lock controlling process of the third embodiment shown in FIG. 15, etc., in parallel with each other. Respective processing of the lock controlling process according to the third embodiment are identical to those of the first embodiment and the second embodiment, and therefore, a detailed description thereof is omitted.

The lock controlling process according to the third embodiment is started when the power of the display 14 is turned-on, in a state that the locked state is being set (the lock flag 340 is being turned-on) as similar to the first embodiment.

The processor 30 displays the lock screen in a step S71, and then, the processor 30 determines in a step S73 whether the touch operation to the lock object Ob is performed. It is determined whether the lock object Ob is touched as shown in FIG. 14(B), for example. If “NO” is determined in the step S73, that is, if the touch operation to the lock object Ob is not performed, the processor 30 repeatedly performs the processing of the step S73. If “YES” is determined in the step S73, that is, if the lock object Ob is touched, the processor 30 performs the voice controlling function in a step S75. The processor 30 that performs the processing of the step S75 functions as a voice controlling function performing module.

Subsequently, in a step S77, the processor 30 determines whether the finger is released. That is, it is determined whether the finger is released by a touch operation that is not associated with a canceling operation of the locked state. If “YES” is determined in the step S77, that is, if the finger is released while the lock object Ob is not moved, for example, the voice controlling function is ended, and the process returns to the step S71. In addition, although a detail will be described later, in a case where the finger is released in the canceling operation of the locked state, “YES” is determined in a step S89 after “NO” is determined in the step S77.

If “NO” is determined in the step S77, that is, if the finger is not released, the processor 30 determines whether a voice is input in a step S79. If “YES” is determined in the step S79, that is, if the voice is input, the processor 30 performs the voice recognizing processing in a step S81, and determines whether a function can be specified based on a voice recognition result in a step S83.

If “NO” is determined in the step S83, that is, if the function cannot be specified based on the voice recognition result, the process returns to the step S79. If “YES” is determined in the step S83, that is, if the function can be specified based on the voice recognition result, the processor 30 turns-off the lock flag 340 in a step S85, and performs the function corresponding to the voice recognition result in a step S87, and then, terminates the lock controlling process.

Furthermore, if no voice is input in a state that the voice controlling function is being performed, the processor 30 determines “NO” in the step S79, and then, determines whether an operation is a canceling operation in the step S89. If “NO” is determined in the step S89, that is, if the canceling operation is not performed, the process by the processor 30 returns to the step S71. If “YES” is determined in the step S89, that is, if the canceling operation is performed, the processor 30 turns-off the lock flag 340 in a step S91, and displays the stand-by screen in a step S93, and then terminates the lock controlling process.

In addition, the first embodiment to the third embodiment can be arbitrarily combined with each other, but specific combination is thinkable easily, and therefore, a detailed description thereof is omitted.

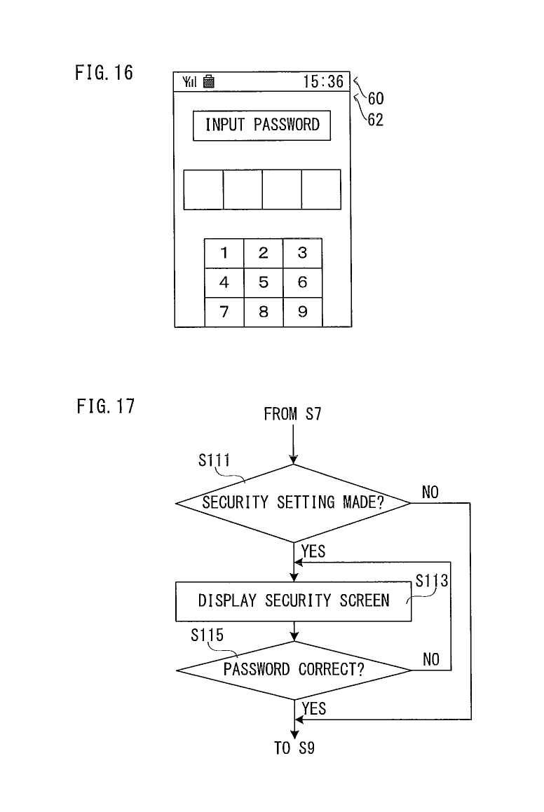

In another embodiment, a security setting may be made, in which a security screen requesting an input of a password is displayed when the canceling operation of the locked state is performed. If the canceling operation is performed to the lock object Ob, the security screen shown in FIG. 16, for example, is displayed on the display 14. Then, if a correct password is input in the security screen, the stand-by screen shown in FIG. 4(C) is displayed on the display 14, but if an erroneous password is input, a re-input of a password is requested.

With referring to FIG. 17, in a case where the security setting is made, if the lock flag 340 is turned-off in the step S7 in the lock controlling process, the processor 30 determines whether the security setting is made in a step S111. That is, it is determined whether a flag corresponding to the security setting is turned-on. If “NO” is determined in the step S111, that is, if the security setting is not made, the process by the processor 30 proceeds to the step S9 to display the stand-by screen. If “YES” is determined in the step S111, that is, in a case where the security setting is made, the processor 30 displays the security screen in a step S113 and determines whether the password is correct in a step S115. That is, the security screen shown in FIG. 16 is displayed on the display 14, and it is determined whether the password that is input in this screen is correct. If “NO” is determined in the step S115, that is, if the password that is input is in error, the process by the processor 30 returns to the step S113. If “YES” is determined in the step S115, that is, if the password that is input is correct, the processor 30 displays the stand-by screen in the step S9. Then, in a case where the security setting is made, the above-described security screen is displayed even after the finger is released in a state that an arbitrary shortcut icon C is selected in the shortcut screen. Therefore, in the lock controlling process according to this embodiment, steps similar to the steps S111 to S115 are added between the step S21 and step S23.

Furthermore, the number of the shortcut icons C included in the shortcut screen is not limited to twelve, and in another embodiment, the same may be equal to or less than eleven or equal to or more than thirteen. An arrangement of the shortcut icons C is not limited to a matrix of 4×3, but the shortcut icons C may be arranged in a ring shape, etc. A change of the displaying manner of the shortcut icon C that is being selected may be a change of a thickness of an edge line other than the reverse of the color, and the shortcut icon C may be displayed with being enlarged or being reduced in size. Furthermore, in order to make the shortcut icon C that is being selected more visible, the displaying of the selecting object SO that selects the shortcut icon C may be reduced in size.

The predetermined function corresponding to the shortcut icon C may be another function such as a voice recorder or the like other than the telephone function and the mail function.

If the incoming telephone call occurs at a time that the touch operation is being performed to the lock object Ob or the selecting object SO, the displaying of the object to which the touch operation is being performed is non-displayed, and a reply screen for the incoming telephone call is displayed. The reply screen of the incoming telephone call includes an incoming telephone call replying object for canceling the locked state and replying the incoming telephone call. If an operation that is similar to the canceling operation to the lock object Ob is performed to the incoming telephone call replying object, a telephone communication is started.

Furthermore, if an operation that is similar to the canceling operation of the lock object Ob is performed to the selecting object SO in a state that the shortcut icon C is not selected by the selecting object SO (FIG. 5(B)), the locked state may be canceled and the stand-by screen may be displayed.

An initial position of the selecting object SO may be the center of the displaying. In a case where the initial position of the selecting object SO is the center of the displaying, the shortcut icons C, etc. are arranged so as to avoid the initial position of the selecting object SO.

The programs used in the embodiments may be stored in an HDD of the server for data distribution, and distributed to the mobile phone 10 via the network. The plurality of programs may be stored in a storage medium such as an optical disk of CD, DVD, BD (Blu-ray Disc) or the like, a USB memory, a memory card, etc. and then, such the storage medium may be sold or distributed. In a case where the programs downloaded via the above-described server or storage medium are installed to a mobile terminal having the structure equal to the structure of the embodiments, it is possible to obtain advantages equal to the advantages according to the embodiments.

The specific numerical values mentioned in this specification are only examples, and changeable appropriately in accordance with the change of product specifications.

An embodiment is a mobile terminal capable of setting a locked state that restricts a performance of predetermined processing, comprising: a display portion; a touch panel that is provided on the display portion; a detecting module operable to detect a touch operation to the touch panel; an icon displaying processing module operable to display at least one or more icons corresponding to predetermined functions on the display portion if a long-depressing touch operation to the touch panel is performed at a time that the locked state is being set; a canceling module operable to cancel the locked state if a touch operation for selecting any one of the icons being displayed on the display portion is performed; and a performing module operable to perform, if the touch operation for selecting any one of the icons being displayed on the display portion is performed, a function corresponding to the icon.

In the embodiment, the mobile terminal (10: a reference numeral exemplifying a module corresponding in the embodiment, and so forth) has the display portion (14) that is a display, the touch panel (16) that is provided on the display portion and the detecting module (48) that detects an input by a touch operation such as a touch, release, etc. performed to the touch panel. If the locked state is set in the mobile terminal, the predetermined processing becomes not to be performed. The icon displaying processing module (30, S11) displays a plurality of icons (C) corresponding to a plurality of functions such as a telephone function, mail function, etc., if the long-depressing touch operation having the lock object continue to be touched is performed at a time that the locked state is being set. The canceling module (30, S21, S51) cancels the locked state if the touch operation is performed to the icon corresponding to the telephone function, for example. Then, the performing module (30, S23, S53) performs, if the touch operation is made to the icon corresponding to the telephone function, for example, the telephone function in response to the processing by the canceling module.

According to this embodiment, the user can simply cancel the locked state and perform the predetermined function only by combining touch operations.

Another embodiment is a mobile terminal further comprising an object displaying processing module operable to display an object that receives a canceling operation of the locked state on the display portion, wherein the icon displaying processing module displays, if the long-depressing touch operation to the object is performed, at least one or more icons corresponding to the predetermined functions instead of the object.

In this embodiment, the object displaying processing module (30, S1) displays the object (Ob) that receives the canceling operation of the locked state on the display portion. Then, the icon displaying processing module displays the icons on the display portion instead of the object if the long-depressing touch operation is made to that object.

According to this embodiment, it is possible to encourage the user to perform a touch operation for displaying the icon with utilizing the object that has been displayed.

Furthermore, the screen that the object is displayed can be effectively utilized by displaying a single or a plurality of icons instead of the object.

A further embodiment is a mobile terminal wherein the icon displaying processing module displays at least one or more icons corresponding to the predetermined functions and further displays an edit icon for editing the predetermined functions corresponding to the icons, further comprising an editing module operable to edit at least one or more icons corresponding to the predetermined functions if the touch operation is made.

In the further embodiment, an edit icon (E) is further displayed together with the icon. The editing module (30, S27) edits an arrangement of the icons and the functions, etc. corresponding to the icon in response to the touch operation being performed to the edit icon.

According to the further embodiment, the user can edit the icon to make the usability for the user improved.

A still further embodiment is a mobile terminal wherein the icon displaying processing module further displays, if the long-depressing touch operation is performed, a selecting object corresponding to a touch position, and the performing module cancels the locked state and performs the function corresponding to the icon if the touch is released in a state that any one of the icons is selected by the selecting object.

In the still further embodiment, in a state that the icon is being displayed, the selecting object (SO) corresponding to the touch position is further displayed. Then, if the finger is released in a state that the icon is selected by the selecting object, the locked state is canceled and the function corresponding to the icon is performed.

According to the still further embodiment, since the selecting object is displayed in correspondence to the touch position, it becomes possible for the user to easily perform the touch operation for selecting the icon.

A further embodiment is a mobile terminal wherein the icon displaying module displays the selecting object so as not to be overlapped with displaying of other icons.

According to the further embodiment, by displaying the selecting object at a position that is not overlapped with the displaying of the other icons, it is possible to suppress an erroneous operation from occurring.

A further embodiment is a mobile terminal having a voice controlling function that the predetermined function is performed based on a voice that is input, wherein the icon displaying processing module further displays a specific icon corresponding to the voice controlling function if the long-depressing touch operation is performed to the touch panel at a time that the locked state is set, and further comprising a voice controlling function performing module that performs the voice controlling function if the touch operation is performed to the specific icon, wherein if the voice corresponding to the predetermined function is input in a state that the voice controlling function is being performed, the performing module cancels the locked state and performs the function corresponding to the voice that is input.

In the further embodiment, the mobile terminal recognizes a voice of the user. The voice controlling function performs the predetermined function based on the voice of the user that is recognized. The icon displaying processing module displays the specific icon (V) on the display portion in addition to the plurality of icons. The voice controlling function performing module (30, S75) performs the voice controlling function if the touch operation for selecting the specific icon, for example, is performed. Then, the performing module cancels the locked state and performs the function corresponding to the voice if the voice corresponding to the predetermined function is input at a time that a specific icon is being selected and the voice controlling function is being performed.

According to the further embodiment, the user can perform the predetermined function only by inputting the voice in addition to the touch operation.

The other embodiment is a lock control method of a mobile terminal (10) having a display portion (14), a touch panel (16) that is provided on the display portion and a detecting module (48) operable to detect a touch operation to the touch panel, and capable of setting a locked state that restricts a performance of predetermined processing based on a touch operation to the touch panel, comprising steps of: displaying (S11) at least one or more icons (C) corresponding to predetermined functions on the display portion if a long-depressing touch operation to the touch panel is performed at a time that the locked state is being set; canceling (S21, S51) the locked state if a touch operation for selecting any one of the icons being displayed on the display portion is performed; and performing (S23, S53), if a touch operation for selecting any one of the icons being displayed on the display portion is performed, a function corresponding to the icon.

In the other embodiment, the user can simply cancel the locked state and perform a predetermined function only by combining the touch operations.

Although the present invention has been described and illustrated in detail, it is clearly understood that the same is by way of illustration and example only and is not to be taken by way of limitation, the spirit and scope of the present invention being limited only by the terms of the appended claim.

### DESCRIPTION OF NUMERALS

10 denotes mobile phone,
14 denotes a display,
16 denotes a touch panel,
30 denotes a processor,
40 denotes an input device,
44 denotes a flash memory, and
46 denotes a RAM.

1. A mobile terminal capable of setting a locked state that restricts a performance of predetermined processing, comprising:
a display portion;
a touch panel that is provided on the display portion;
a detecting module operable to detect a touch operation to the touch panel;
an icon displaying processing module operable to display at least one or more icons corresponding to predetermined functions on the display portion if a long-depressing touch operation to the touch panel is performed at a time that the locked state is being set;
a canceling module operable to cancel the locked state if a touch operation for selecting any one of the icons being displayed on the display portion is performed; and
a performing module operable to perform, if the touch operation for selecting any one of the icons being displayed on the display portion is performed, a function corresponding to the icon.

2. A mobile terminal according to claim 1, further comprising an object displaying processing module operable to display an object that receives a canceling operation of the locked state on the display portion,
wherein the icon displaying processing module displays, if the long-depressing touch operation to the object is performed, at least one or more icons corresponding to the predetermined functions instead of the object.

3. A mobile terminal according to claim 1, wherein the icon displaying processing module displays at least one or more icons corresponding to the predetermined functions and further displays an edit icon for editing the predetermined functions corresponding to the icons, further comprising
an editing module operable to edit at least one or more icons corresponding to the predetermined functions if the touch operation is made.

4. A mobile terminal according to claim 1, wherein the icon displaying processing module further displays, if the long-depressing touch operation is performed, a selecting object corresponding to a touch position, and
the performing module cancels the locked state and performs the function corresponding to the icon if the touch is released in a state that any one of the icons is selected by the selecting object.

5. A mobile terminal according to claim 4, wherein the icon displaying module displays the selecting object so as not to be overlapped with displaying of other icons.

6. A mobile terminal according to claim 1, wherein the mobile terminal has a voice controlling function that the predetermined function is performed based on a voice that is input, and the icon displaying processing module further displays a specific icon corresponding to the voice controlling function if the long-depressing touch operation is performed to the touch panel at a time that the locked state is set, further comprising
a voice controlling function performing module that performs the voice controlling function if the touch operation is performed to the specific icon,
wherein if the voice corresponding to the predetermined function is input in a state that the voice controlling function is being performed, the performing module cancels the locked state and performs the function corresponding to the voice that is input.

7. A lock control method of a mobile terminal having a display portion, a touch panel that is provided on the display portion and a detecting module operable to detect a touch operation to the touch panel, and capable of setting a locked state that restricts a performance of predetermined processing based on a touch operation to the touch panel, comprising steps of:
displaying at least one or more icons corresponding to predetermined functions on the display portion if a long-depressing touch operation to the touch panel is performed at a time that the locked state is being set;
canceling the locked state if a touch operation for selecting any one of the icons being displayed on the display portion is performed; and
performing, if a touch operation for selecting any one of the icons being displayed on the display portion is performed, a function corresponding to the icon.
